(19) United States
(12) Patent Application Publication
(10) Pub. No.: US 2022/0251694 A1
(43) Pub. Date: Aug. 11, 2022

(54) HIGH-SILICON ALUMINUM ALLOY ELECTRONIC PACKAGING SHELL AND MANUFACTURING METHOD THEREOF

(71) Applicant: CENTRAL SOUTH UNIVERSITY, Changsha (CN)

(72) Inventors: Zhiyong CAI, Changsha (CN); Richu WANG, Changsha (CN)

(21) Appl. No.: 17/495,441

(22) Filed: Oct. 6, 2021

(30) Foreign Application Priority Data
Feb. 10, 2021 (CN) 202110187031.2

(51) Int. Cl. C22F 1/043; C22C 21/02

(52) U.S. Cl. CPC C22F 1/043; C22C 21/02

(57) ABSTRACT

Disclosed is a method of manufacturing a high-silicon aluminum alloy electronic packaging shell, which uses high-silicon aluminum alloys with different silicon content as a bottom, transition part(s) and a welding part respectively to form a gradient material structure to meet the comprehensive requirements of electronic packaging materials for material properties such as strength, thermal conductivity, and thermal expansion coefficient, as well as process properties such as machining, surface coating, and laser welding.

### CROSS REFERENCE TO RELATED APPLICATIONS

This application claims priority to Chinese patent application No. CN 202110187031.2 having a filing date of Feb. 10, 2021, the entire contents of which are hereby incorporated by reference.

### FIELD OF TECHNOLOGY

The following relates to the technical field of metal and alloy manufacturing, and specifically relates to a high-silicon aluminum alloy electronic packaging shell and a manufacturing method thereof.

### BACKGROUND

The electronic packaging shell provides electrical/thermal access, mechanical support and environmental protection for chips, which is the basis for stable and highly reliable service of components. It requires not only good mechanical and thermal physical properties, but also to meet the process requirements of machining, surface plating, laser welding, and the like. At present, aluminum-based composite materials reinforced with silicon particles, silicon carbide particles, carbon fibers and diamond particles have the advantages of low density, high thermal conductivity, and adjustable expansion coefficient, which have become the research hotspot of electronic packaging materials nowadays. The third-generation packaging materials represented by Al/SiCₚ composites have good mechanical and thermophysical properties, but in practical application, they are faced with some prominent problems, such as the difficulty of machining and surface plating, the inability of laser welding, and the difficulty of welding shell and cover to meet the requirements of air tightness.

High-silicon aluminum alloy has the characteristics of high thermal conductivity, thermal expansion coefficient compatible with chips, high specific strength, low density (<2.7 g/cm³), easy processing and welding, etc., which has become a kind of electronic packaging shell material with broad application prospect. However, the existing single homogeneous high-silicon aluminum alloy electronic packaging material is difficult to meet the comprehensive requirements for material properties such as thermal expansion matching, high thermal conductivity, machining, and welding, as well as process properties. For example, high-silicon aluminum alloy with higher silicon content (≥50%) has lower density and thermal expansion coefficient but low thermal conductivity, poor laser welding performance, difficult machining, and low yield, while high-silicon aluminum alloy with lower silicon content has high thermal conductivity, good laser welding and machining performance, but its thermal expansion coefficient cannot match chips.

Therefore, based on the actual application requirements, the development of structure-function integrated high-silicon aluminum alloy electronic packaging is an effective way to solve the matching problem between material performance and process performance. The structure-function integrated high-silicon aluminum alloy includes integrated high-silicon aluminum alloys with different silicon content. The high-silicon aluminum alloy with higher silicon content has a lower thermal expansion coefficient and higher strength, meeting the requirements of circuit and chip integration, suitable for packaging with ceramic substrates; while the high-silicon aluminum alloy with lower silicon content has good thermal conductivity, is easy to be processed and sealed, and meets the requirements of drilling, welding and sealing of the sidewall of the packaging shell, and is suitable for heat dissipation surface. At the same time, according to actual application requirements, intermediate transition layers with different silicon contents can also be designed to reduce the thermal stress of gradient materials and optimize their distribution. Chinese Patent “High-throughput preparation device and method of high-silicon aluminum alloy structure gradient material for packaging” (105970013B) discloses a high-throughput preparation device and high-throughput preparation method of gradient high-silicon aluminum alloy. However, from the application point of view, there are few reports on the structure-function integrated design and manufacture of high-silicon aluminum alloy electronic packaging shells.

At present, functionally gradient materials are mostly prepared by powder metallurgy, pressureless infiltration and other methods. The paper “Preparation and characterization of Sip/Al functionally graded materials by powder metallurgy hot-press” (Powder Metallurgy Industry, 2014, 24(1): 39-43) reports the preparation of Sip/Al functionally graded material by hot pressing. The paper “Preparation of SiCₚ/Al Composites with Different SiC Volume Fraction and Compositional Graded SiCₚ/Al Composites by pressureless Infiltration Processing” (2006, Journal of Materials Engineering, 6:13-16) reports that SiCₚ/Al composites with 6 volume fraction gradients of low, medium and high volume fractions were prepared by pressureless impregnation processing. The paper “Fabrication of tungsten/copper functionally gradient materials with nearly fully density by hot press” (The Chinese Journal of Nonferrous Metals, 2007, 17(9): 1410-1616) reports that high density W—Cu functionally gradient material was fabricated by particle size distribution method and hot press. Chinese Patent “Method of preparing gradient silicon aluminum alloy electronic packaging material by rapid hot pressing” (102358924B) discloses the preparation of gradient high silicon aluminum alloy electronic packaging material by gas atomization and hot pressing sintering. However, there are few reports on the spray deposition preparation method of the high-silicon aluminum alloy structure-function integrated material, and there is still a certain gap between the existing technology and the mass-stabilized production.

### SUMMARY

One aspect of the disclosure is relates to a method of manufacturing a high-silicon aluminum alloy electronic packaging shell, including the steps of:
S1: designing a silicon aluminum alloy gradient material ingot and a size of the electronic packaging shell; the gradient material ingot includes a connection layer, transition layer(s) and a welding layer, the transition layer(s) is located between the connection layer and the welding layer, the number of the transition layer(s) is ≥0, and the gradient material ingot has a silicon content gradient that decreases along a direction from the connection layer to the welding layer; the electronic packaging shell includes a bottom and a side wall, the bottom and the side wall are enclosed to form a holding space, the side wall is composed of transition part(s) and a welding part, the transition part(s) is located between the bottom and the welding part, and the number of the transition part(s) is ≥0;
S2: using silicon aluminum alloys with different silicon contents as raw materials, and depositing the connection layer, the transition layer(s) and the welding layer in sequence by atomized spray deposition process to form the gradient material ingot designed by the step S1;
S3: densifying the gradient material ingot;
S4: cutting the gradient material ingot into the electronic packaging shell; the bottom is formed by cutting the connection layer, and the side wall is formed by cutting the transition layer(s) and the welding layer; and
S5: annealing the electronic packaging shell.

In some embodiments, the step S1 includes: (1) detecting quantitative relationships between silicon content and material properties and process properties of silicon aluminum alloy; (2) referring to temperature and thermal stress distribution of known typical silicon aluminum alloy electronic packaging shell, and according to the quantitative relationships, designing respective composition and thickness of the bottom, the transition part(s) and the welding part.

In some embodiments, in the step (1), the material properties include tensile strength, hardness, thermal conductivity and thermal expansion coefficient, and the process properties include machining, surface plating and laser welding.

In some embodiments, the step (2) includes: setting a preset composition and a preset thickness of the bottom and a preset composition of the welding part, then taking the preset composition and the preset thickness of the bottom and the preset composition of the welding part as known quantities, calculating and designing the composition and thickness of the transition part(s) and the thickness of the welding part by using thermoelastic theory and finite element method, then taking the composition and the thickness of the transition part(s) and the thickness of the welding part as known quantities, calculating and designing the composition and the thickness of the bottom and the composition of the welding part by using thermoelastic theory and finite element calculation.

In some embodiments, the method further includes S6: characterizing the electronic packaging shell, and cycling the steps S1-S5 according to characterization results to optimize the respective composition and thickness of the bottom, the transition part(s) and the welding part.

In some embodiments, a silicon mass content of the connection layer is 50-70%, a silicon mass content of the transition layer(s) is 35-50%, and a silicon mass content of the welding layer is 12-35%.

Another aspect of the disclosure is relates to an electronic packaging shell, including a bottom and a side wall; the bottom and the side wall are enclosed to form a holding space, the side wall is composed of a transition part(s) and a welding part, the transition part(s) is located between the bottom and the welding part, and the number of transition part(s) is ≥0; the electronic packaging shell is formed from silicon aluminum alloys with different silicon contents as raw material through atomized spray deposition process, densification, annealing and cutting, and has a silicon content gradient that decreases along a direction from the bottom to the welding part.

The manufacturing method according to the disclosure uses the material structure-function integrated design idea to propose a gradient material structure composed of the bottom, the transition part and the welding part, which meets the comprehensive requirements of electronic packaging material for material properties such as the strength, thermal conductivity and thermal expansion coefficient, as well as process properties such as machining, surface coating and laser welding. The atomized spray deposition process used in the manufacturing method makes the electronic packaging shell have clear interfaces. The solid gradient material ingot 100′ is cut into box shape that can accommodate a chip. And the process of the method is highly controllable, which can obtain different gradient material structure of high-silicon aluminum alloy with good continuity and stability, and is suitable for industrial production.

### BRIEF DESCRIPTION OF THE DRAWINGS

Some of the embodiments will be described in detail, with reference to the following figures, wherein like designations denote like members, wherein:

FIG. 1 is a flow diagram of a high-silicon aluminum alloy electronic packaging shell according to some embodiments of the disclosure;

FIG. 2 is a structural diagram of a known typical high-silicon aluminum alloy electronic packaging shell;

FIG. 3 (a)-(f) are SEM images of different single homogeneous high-silicon aluminum alloys prepared via atomized spray deposition process;

FIG. 4 is a relationship diagram between silicon content difference between gradient layers and equivalent internal stress of gradient interface;

FIG. 5 is a relationship diagram between process properties and silicon content of single homogeneous high-silicon aluminum alloys prepared via atomized spray deposition process;

FIG. 6 is a structural diagram of a high-silicon aluminum alloy electronic packaging shell with a single transition part according to some embodiments;

FIG. 7 is a relationship diagram between thickness of transition part and equivalent internal stress of gradient interfaces;

FIG. 8 is a relationship diagram between silicon content of transition part and equivalent internal stress of gradient interfaces;

FIG. 9 is a structural diagram of a high-silicon aluminum alloy electronic packaging shell with double transition parts according to some embodiments; and

FIG. 10 is a structural diagram of a silicon aluminum alloy gradient material ingot according to some embodiments.

### DETAILED DESCRIPTION

It should be understood that the specific embodiments described here are only used to explain the embodiments of the present disclosure, but not to limit the embodiments. In addition, it should be noted that, for ease of description, the drawings only show a part of the structure related to the embodiment of the present disclosure, but not all of the structure.

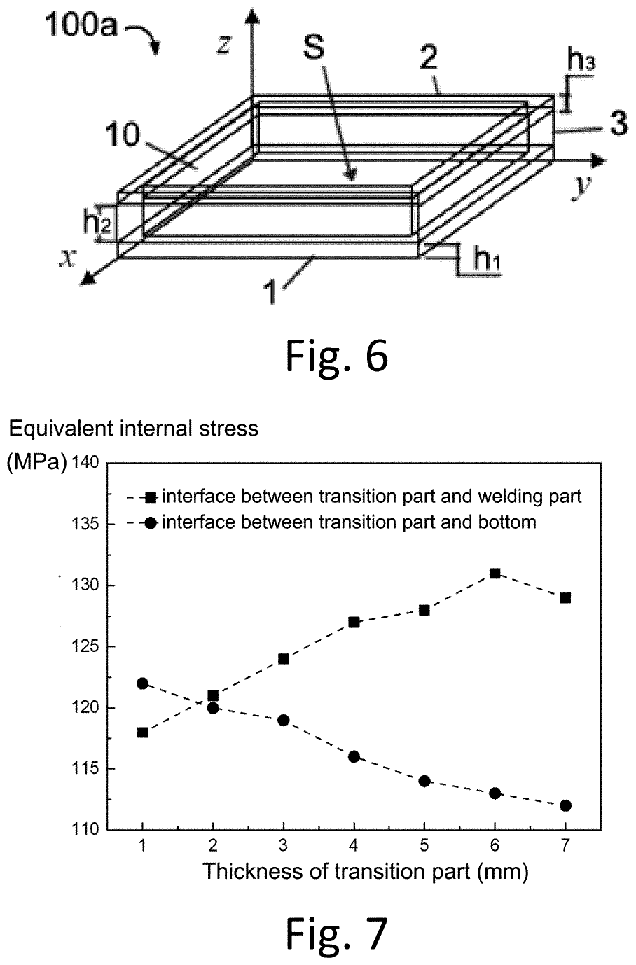

Refer to FIG. 6 or FIG. 9, a high-silicon aluminum alloy electronic packaging shell provided by the disclosure includes a bottom 1 and a side wall 10, wherein the bottom 1 and the side wall 10 are enclosed to form a holding space S, the side wall 10 is composed of transition part(s) 3 and a welding part 2, the transition part(s) 3 is located between the bottom 1 and the welding part, and the number of the transition part(s) 3 is ≥0.

Moreover, the electronic packaging shell is formed from silicon aluminum alloys with different silicon concentrations as raw material through atomized spray deposition process, densification, annealing and cutting, and has a silicon concentration gradient that decreases along a direction from the bottom 1 to the welding part 2.

In some embodiments, the silicon mass content of the bottom 1 is 50-70%, the silicon mass content of the transition part(s) 3 is 35-50%, and the silicon mass content of the welding part 2 is 12-35%.

Through calculation and characterization, it can be concluded that the electronic packaging shell has high heat dissipation efficiency and small thermal stress.

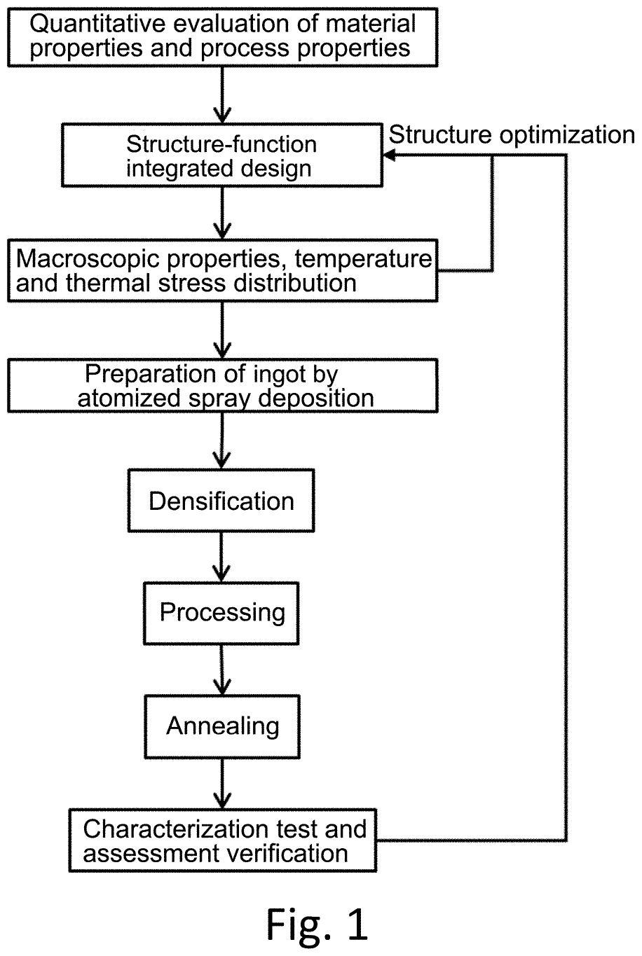

As shown in FIG. 1, a method of manufacturing the high-silicon aluminum alloy electronic packaging shell provided by the disclosure includes the following steps:

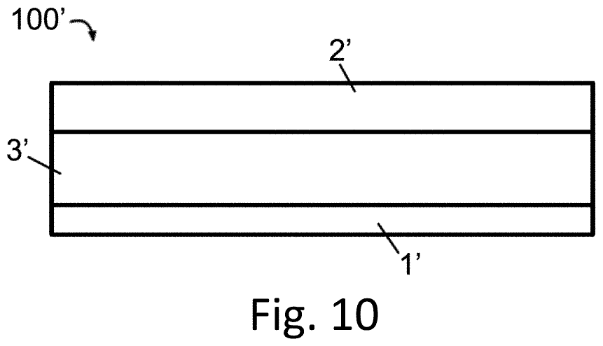

S1: Designing a silicon aluminum alloy gradient material ingot 100′ and a size of the electronic packaging shell; as shown in FIG. 10, the gradient material ingot 100′ includes a connection layer 1′, transition layer(s) 3′ and a welding layer 2′, the transition layer(s) 3′ is located between the connection layer 1′ and the welding layer 2′, the number of the transition layer(s) 3′ is ≥0, and the gradient material ingot 100′ has a silicon concentration gradient that decreases along a direction from the connection layer 1′ to the welding layer 2′;

S2: Using silicon aluminum alloys with different silicon concentrations as raw materials, and depositing the connection layer 1′, the transition layer(s) 3′ and the welding layer 2′ in sequence by atomized spray deposition process to form the gradient material ingot 100′ designed by the step S1;

S3: Densifying the gradient material ingot 100′;

S4: Cutting the gradient material ingot 100′ into the electronic packaging shell; the bottom 1 is formed by cutting the connection layer 1′, and the side wall 10 is formed by cutting the transition layer(s) 3′ and the welding layer 2′; and

S5: Annealing the electronic packaging shell.

The manufacturing method according to the disclosure uses the material structure-function integrated design idea to propose a gradient material structure composed of the bottom, the transition part and the welding part, which meets the comprehensive requirements of electronic packaging material for material properties such as the strength, thermal conductivity and thermal expansion coefficient, as well as process properties such as machining, surface coating and laser welding. The atomized spray deposition process used in the manufacturing method makes the electronic packaging shell have clear interfaces. The solid gradient material ingot 100′ is cut into box shape that can accommodate a chip. And the process of the method is highly controllable, which can obtain different gradient material structure of high-silicon aluminum alloy with good continuity and stability, and is suitable for industrial production.

The step S1 includes: (1) for a number of high-silicon aluminum alloys with different silicon contents, detecting quantitative relationships between silicon concentration and material properties and process properties of silicon aluminum alloy; (2) referring to the temperature and thermal stress distribution of a known typical silicon aluminum alloy electronic packaging shell, and according to the quantitative relationships, designing respective composition and thickness of the bottom 1, transition part(s) 3 and welding part 2. By establishing the quantitative relationship between the silicon content of the existing single homogeneous high silicon aluminum alloy and the properties, it provides a reference for the design of the electronic packaging shell.

In the step (1), the quantitative relationship between material properties and silicon content of a single homogeneous high-silicon aluminum alloy material is established, as well as the quantitative relationship between process properties and silicon content is evaluated; the material properties include tensile strength, hardness, thermal conductivity and thermal expansion coefficient, and the process properties include machining, surface plating and laser welding. By evaluating material properties and process properties in advance, the structure is designed from function to meet the comprehensive requirements of electronic packaging materials for material properties such as strength, thermal conductivity and thermal expansion coefficient, as well as process properties such as machining, surface plating and laser welding.

The step (2) includes: presetting the size of the electronic packaging shell, setting a preset composition and a preset thickness h₁ of the bottom 1 and a preset composition of the welding part 2, then taking the preset composition and the preset thickness h₁ of the bottom 1 and the preset composition of the welding part 2 as known quantities, calculating and designing the composition and the thickness h₂ of the transition part(s) 3 and the thickness h₃ of the welding part 2 by using thermoelastic theory and finite element method, then taking the composition and the thickness h₂ of the transition part(s) 3 and the thickness h₃ of the welding part 2 as known quantities, calculating and designing the composition and the thickness h₁ of the bottom 1 and the composition of the welding part 2 by using thermoelastic theory and finite element calculation.

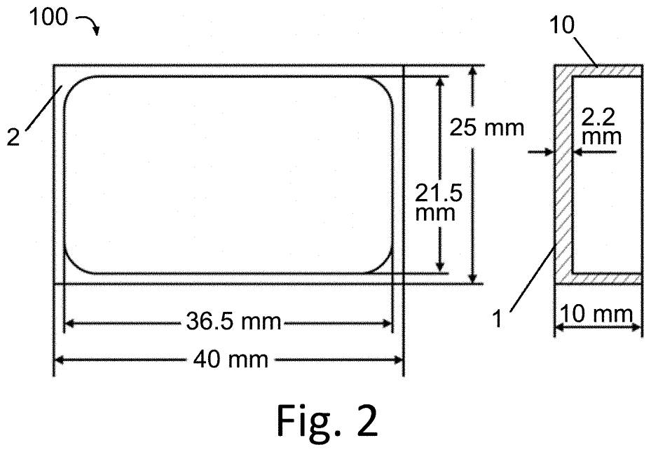

Shown by FIG. 2, referring to the size of the known typical high-silicon aluminum alloy electronic packaging shell 100, the composition and the thickness h₁ of the bottom 1 and the composition of the welding part 2 are preset, so that the design process is simplified to design the composition of the transition part 3 and the thicknesses h₂, h₃ of the transition part 3 and the welding part 2, the longitudinal (Z-axis) properties of high-silicon aluminum alloy gradient materials with different structures are inferred, and the temperature distribution and thermal stress distribution are simulated to seek the material composition and thickness design with high heat dissipation efficiency and minimum thermal stress. Then with the designed composition of the transition part 3 and the designed thicknesses h₂, h₃ of the transition part 3 and the welding part 2, the composition and the thickness h₁ of the bottom 1 and the composition of the welding part 2 are recalculated. Finally, a complete design proposal of the electronic packaging shell is ready.

Specifically, for simplification and saving time, the size of the electronic packaging shell can be preset as 40×25×10 mm (the same size as the typical electronic packaging shell 100 shown in FIG. 2). When the electronic packaging shell is in use, a chip is placed in the holding space S enclosed by the bottom 1 and the welding part 2, and a cover is added to seal the electronic packaging shell, the chip is in direct contact with the bottom 1, and the cover is in direct contact with the welding part 2. So the bottom 1 can be preset as Al-70Si alloy which is the same material of the chip, and its thickness h₁ is preset as 2.2 mm. The welding part 2 can be preset as Al-27Si alloy which is the same material of the cover. Thereafter the main design parameters are simplified to the composition of the transition part 3 and the thicknesses h₂, h₃ of the transition part 3 and the welding part 2. The composition of the transition part 3 and the thicknesses h₂, h₃ of the transition part 3 and the welding part 2 are figured out by using thermoelastic theory and finite element calculation. With the composition of the transition part 3 and the thicknesses h₂, h₃ of the transition part 3 and the welding part 2 as known parameters, the compositions of the bottom 1 and the welding part 2 and the thickness h₁ of the bottom 1 are calculated by using thermoelastic theory and finite element calculation. In such a way, the compositions of the bottom 1, the transition part 3 and the welding part 2 and their thicknesses are all worked out.

In the step S2, the raw material of the silicon aluminum alloy is heated to a melt, which is kept at a temperature of 120-250° C. above its liquidus temperature.

The step S2 uses an atomization deposition device. The atomization deposition device is specifically a dual atomization system deposition device, which includes a microcomputer control part, two atomization parts, a deposition part and a monitoring part. The microcomputer control part controls the two atomization parts, the deposition part and the monitoring part.

The atomization part includes a nozzle, an atomizer, a gas connection device, a gas connection device controller, a blocking rod and a blocking rod controller (start and stop). The gas connection device controller controls the gas connection device to spray high-pressure gas, the melt is dispersed by the high-pressure gas and forms atomized droplets through the atomizer and nozzle, which fly under the action of the high-pressure gas, gradually cool and solidify, and finally deposit on the deposition part. The two atomizing parts are switched quickly and seamlessly. When one atomization part is working, the other atomization part is standby, and stop and start of the atomization part are controlled by the blocking rod and the blocking rod controller. The deposition part includes a deposition substrate, a deposition substrate rotatory device and a lowering device. When the melt is deposited to a certain extent, the rotation and lowering of the deposition substrate are controlled by the deposition substrate rotatory device and the lowering device to keep a distance from the upcoming deposited atomized droplets. Preparation of the gradient alloy ingot by the dual atomization system deposition device can be continuously operated for atomization and deposition, which improves efficiency, has high precision, high repeatability, and is convenient for design, etc., with less subsequent processing, good continuity and stability, and suitable for industrial production.

In the step S2, the high-pressure gas is nitrogen with the gas pressure of 0.7-1.2 MPa. A smelting part is provided above the atomization device, which smelts the raw material to a melt. The smelting part includes two medium-frequency induction melting furnaces, and the aluminum alloy used in the bottom and the welding part 2 is smelted in the two medium-frequency induction melting furnaces respectively, with the melting temperature of 1200-1500° C.

In the step S3, the gradient material ingot 100′ is densified by one of hot isostatic pressing, hot pressing sintering and spark plasma sintering, and a densification temperature of 480-550° C., a holding time of 1-4 hours, a heating rate of 10-40° C./hour and a cooling rate of 20-50° C./hour are adopted. Before reaching the densification temperature, the gradient material ingot 100′ is kept at 400° C. for one hour. Through proper densification treatment, the total volume of the internal voids of the gradient material ingot 100′ is reduced, the particle spacing thereof is shortened, and the density of the gradient material ingot 100′ is increased.

The air tightness of the gradient material ingot 100′ prepared in the step S3 is higher than 1×10⁻⁹ Pa·m³/s, the interfaces between the layers with different silicon content inside maintain a linear distribution, each interface between the layers is flat, and the deviation is less than 0.2 mm.

In the step S4, a block is cut from the gradient material ingot 100′, and the block is cut into a size consistent with the electronic packaging shell. Specifically, the block is cut from the gradient alloy ingot 100′ by wire cutting, and the side wall and the bottom are processed by a fine engraving machine to the size consistent with the electronic package shell. Due to design in advance and deposited preparation, the processing volume of the bottom 1, the transition part 3 and the welding part 2 can be controlled within 0.2˜0.5 mm, and the electronic packaging shell can be obtained, which saves materials.

In the step S5, an annealing temperature of 320-440° C. and a holding time of 6-24 hours are adopted, and a pressure of 0.5-5 MPa is applied above the electronic packaging shell during annealing. Through proper annealing treatment, residual stress is reduced, size is stabilized, and deformation and cracking tendency are reduced.

The method further includes S6: Characterizing the electronic packaging shell, and cycling the steps S1-S5 according to characterization results to optimize the respective composition and thickness of the bottom 1, the transition part (s) 3 and the welding part 2. Through continuous design optimization, the thickness distribution and material system with high heat dissipation efficiency and minimum thermal stress are sought. Specifically, in this step S6, the microstructure and gradient interface structure of the prepared electronic packaging shell are characterized, and its tensile strength, bending strength, thermal conductivity and thermal expansion coefficient are tested to optimize the respective composition and thickness of the bottom 1, the transition part(s) 3 and the welding part 2.

### Embodiment 1

In this embodiment, a method of manufacturing a high-silicon aluminum alloy electronic packaging shell includes steps of:

S1: Designing a silicon aluminum alloy gradient material ingot 100′ and a size of the electronic packaging shell.

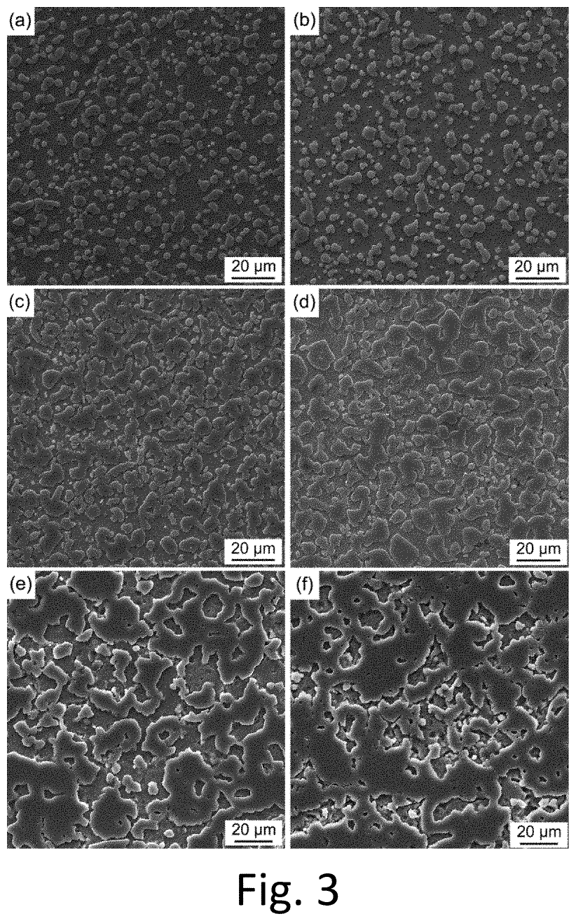

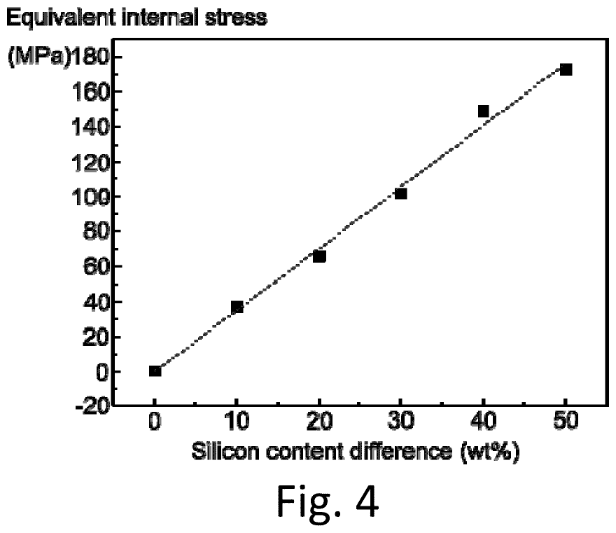

(1) Testing the quantitative relationship between silicon content and material properties and process properties of a number of conventional high-silicon aluminum alloys. A number of high-silicon aluminum alloys are prepared by atomized spray deposition process, and the microstructures are characterized respectively, with the results shown in FIG. 3. FIG. 3(a) is the SEM image of the Al-22% Si alloy, and FIG. 3(b) is the SEM image of Al-27% Si alloy, FIG. 3(c) is the SEM image of Al-42% Si alloy, FIG. 3(d) is the SEM image of Al-50% Si alloy, FIG. 3(e) is the SEM image of Al-60% Si alloy, and FIG. 3(f) is the SEM image of Al-70% Si alloy. The relationship between the silicon content difference and the equivalent internal stress of the gradient interface are tested, with results shown in FIG. 4. The equivalent internal stress of the gradient interface is positively proportional to the silicon content difference between the gradient layers. At the same time, the tensile strength, thermal conductivity and thermal expansion coefficient are tested, as shown by Table 1, to establish the quantitative relationship between the material properties and silicon content of a single homogeneous high silicon aluminum alloy:

TABLE 1
Main properties of high-silicon aluminum alloys
prepared by atomized spray deposition

| | | | | | Thermal Expansion |
|---|---|---|---|---|---|
| | Tensile | Bending | Brinell | Thermal | Coefficient/ |
| Alloy | Strength/ | Strength/ | Hardness/ | Conductivity/ | 10⁻⁶ · K⁻¹ |
| Composition | MPa | MPa | HB | W · m⁻¹ · K⁻¹ | (25-250° C.) |
| Al—22%Si | 145 | 186 | 51 | 186 | 18.9 |
| Al—27%Si | 160 | 202 | 59 | 177 | 17.2 |
| Al—42%Si | 178 | 269 | 109 | 162 | 13.1 |
| Al—50%Si | 183 | 304 | 136 | 147 | 11.2 |
| Al—60%Si | 159 | 286 | 159 | 130 | 8.9 |
| Al—70%Si | 133 | 233 | 168 | 118 | 7.2 |

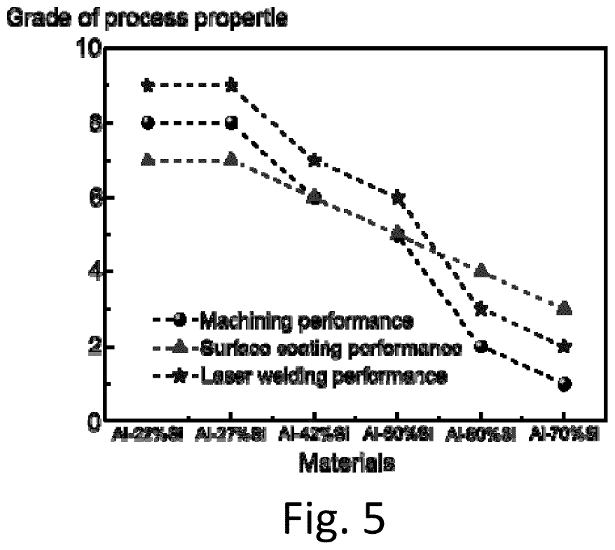

The process properties of the high-silicon aluminum alloys with different silicon content prepared by atomized spray deposition are tested, including machining, surface plating and laser welding, as shown by FIG. 5, to establish the quantitative relationship between the process properties and the silicon content of the single homogeneous high-silicon aluminum alloy, for grading the process properties.

(2) Based on the service conditions and shell structure, the temperature and thermal stress distribution of the known typical high-silicon aluminum alloy electronic packaging shell 100 are analyzed, and as a reference, the composition and thickness of each layer of the electronic packaging shell are figured out by using thermoelastic theory and finite element calculation combined with the results of the step (1). The electronic packaging shell is a box shape, which includes a bottom 1 and a side wall 10, and the bottom 1 and the side wall 10 are enclosed to form a holding space S. The side wall 10 includes transition part(s) 3 and a welding part 2, and the welding part 2 is located above the transition part(s) 3. The number of the transition part(s) 3 can be ≥0, and when the number of the transition part 3 is 0, the welding part 2 is connected with the bottom 1.

According to the known typical high-silicon aluminum alloy electronic packaging shell 100, as shown by FIG. 2, the size of the electronic packaging shell is preset as 40×25×10 mm. The bottom 1 is preset as Al-70Si alloy which is the same material of the chip, and its thickness h₁ is preset as 2.2 mm. The welding part 2 is preset as Al-27Si alloy which is the same material of the cover. Thereafter the main design parameters are simplified to the composition of the transition part 3 and the thicknesses h₂, h₃ of the transition part 3 and welding part 2. The composition of the transition part 3 and the thicknesses h₂, h₃ of the transition part 3 and the welding part 2 are figured out by using the thermoelastic theory and finite element calculation. With the composition of the transition part 3 and the thicknesses h₂, h₃ of the transition part 3 and the welding part 2 as known parameters, the compositions of the bottom 1 and the welding part 2 and the thickness h₁ of the bottom 1 are calculated by using the thermoelastic theory and finite element calculation. In such a way, the compositions of the bottom 1, the transition part 3 and the welding part 2 and their thicknesses are all worked out.

In this embodiment, according to the temperature and thermal stress distribution, a gradient material of Al-35% Si/Al-50% Si are used to prepare the electronic packaging shell, of which Al-35% Si alloy is used for the welding part 2 with thickness of 6.2 mm, and Al-50% Si alloy is used for the bottom 1 with thickness of 1.8 mm. The design of this embodiment has no transition part 3.

S2: Generating a gradient material ingot 100′ via the dual atomization system deposition device, according to the structure of the gradient material of Al-35% Si/Al-50% Si. The gradient material ingot 100′ includes a connection layer 1′ and a welding layer 2′, wherein the silicon content vary gradually from large to small along the direction from the connection layer 1′ to the welding layer 2′. The connection layer 1′ is made of Al-35% Si alloy, and the welding layer 2′ is made of Al-50% Si alloy.

S3: Densifying the gradient material ingot 100′ by hot pressing sintering, with the densification temperature of 550° C., the holding time of 1 hour, the heating rate of 40° C./hour and the cooling rate of 50° C./hour. Before reaching the densification temperature, the gradient material ingot 100′ is kept at 400° C. for one hour.

After testing, the surface quality of the Al-35% Si/Al-50% Si gradient material is good, the interface between the gradient layers is clear with a straight distribution, which has good processing properties and can be processed to a high-silicon aluminum alloy electronic packaging shell, which meets the application requirements.

S4: Cutting the gradient material ingot 100′ into the electronic packaging shell. The connection layer 1′ serves as the bottom 1 after cutting. The welding layer 2′ is cut to form a frame shape, and the welding layer 2′ serves as the welding part 2 after cutting.

The thickness h₃ of the welding part 2 is 6.5±0.1 mm and the thickness h₁ of the bottom 1 is 2.1±0.1 mm, that is, after cutting, the thickness of the Al-35% Si alloy is 6.5±0.1 mm and the thickness of the Al-50% Si alloy is 2.1±0.1 mm. According to the design size, the electronic packaging shell is obtained after further fine engraving and cutting.

S5: Annealing the electronic packaging shell, with the annealing temperature of 320-360° C. and the holding time of 6-12 hours. During the annealing process, the pressure of 0.5-1.5 MPa is applied on the electronic packaging shell.

### Embodiment 2

In this embodiment, a method of manufacturing a high-silicon aluminum alloy electronic packaging shell 100a includes steps of:

S1: Designing a silicon aluminum alloy gradient material ingot 100′ and a size of the electronic packaging shell 100a.

Referring to Table 1 and FIGS. 3-5, based on the service conditions and shell structure, via analyzing the temperature and thermal stress distribution of the known typical high-silicon aluminum alloy electronic packaging shell 100 as a reference, figuring out the composition and thickness of each layer of the electronic packaging shell 100a by using thermoelastic theory and finite element calculation.

As shown by FIG. 6, the electronic packaging shell 100a is a box shape, which includes a bottom 1 and a side wall 10, and the bottom 1 and the side wall 10 are enclosed to form a holding space S. The side wall 10 includes a transition part 3 and a welding part 2, and the welding part 2 is located above the transition part 3. The number of the transition part 3 can be ≥0, and when the number of the transition part 3 is 0, the welding part 2 is connected with the bottom 1.

According to the known typical high-silicon aluminum alloy electronic packaging shell 100, as shown by FIG. 2, the size of the electronic packaging shell 100a is preset as 40×25×10 mm. The bottom 1 is preset as Al-70Si alloy which is the same material of the chip, and its thickness h₁ is preset as 2.2 mm. The welding part 2 is preset as Al-27Si alloy which is the same material of the cover. Thereafter the main design parameters are simplified to the composition of the transition part 3 and the thicknesses h₂, h₃ of the transition part 3 and welding part 2. The composition of the transition part 3 and the thicknesses h₂, h₃ of the transition part 3 and the welding part 2 are figured out by using the thermoelastic theory and finite element calculation. With the composition of the transition part 3 and the thicknesses h₂, h₃ of the transition part 3 and the welding part 2 as known parameters, the compositions of the bottom 1 and the welding part 2 and the thickness h₁ of the bottom 1 are calculated by using the thermoelastic theory and finite element calculation. In such a way, the compositions of the bottom 1, the transition part 3 and the welding part 2 and their thicknesses are all worked out.

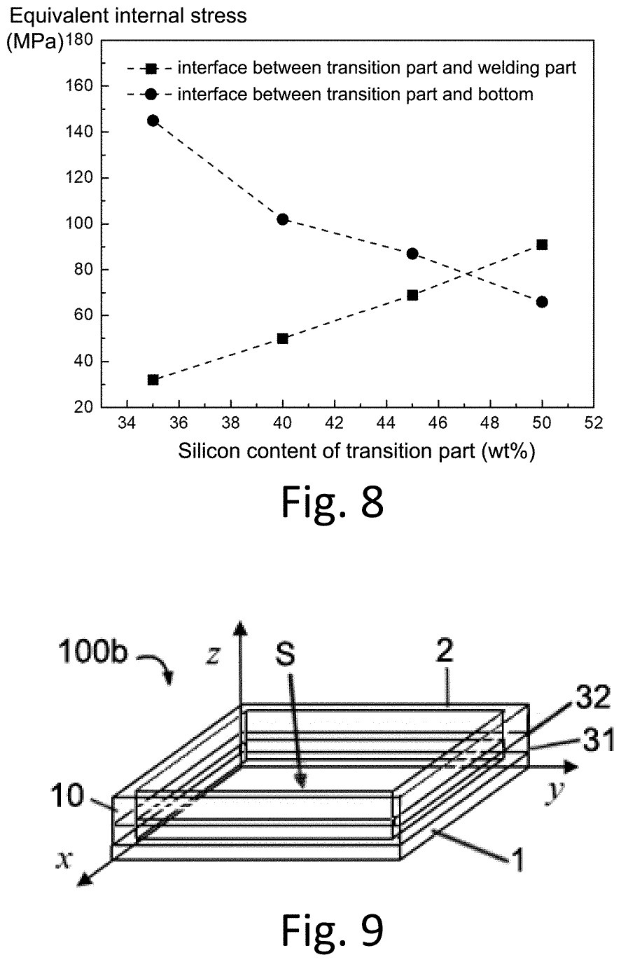

As shown by FIG. 4, since the equivalent internal stress of the gradient interface is proportional to the silicon content difference between the gradient layers, reducing the silicon content difference between the gradient layers is beneficial to reducing the internal stress of the gradient interface, so a transition part 3 is provided, which uses high-silicon aluminum alloy as the material, and the silicon content thereof is between the bottom 1 and the welding part 2. As shown by FIG. 7, the thickness design of the transition part 3 needs to simultaneously consider both the equivalent internal stress of the interface between the transition part 3 and the welding part 2, and the equivalent internal stress of the interface between the transition part 3 and the bottom 1. As shown by FIG. 8, the silicon content design of the transition part 3 needs to simultaneously consider both the equivalent internal stress of the interface between the transition part 3 and the welding part 2, and the equivalent internal stress of the interface between the transition part 3 and the bottom 1.

In this embodiment, according to the temperature and thermal stress distribution, using the method of thermoelastic theory and finite element calculation, a gradient material of Al-12% Si/Al-50% Si/Al-70% Si is used to prepare the electronic packaging shell 100a, of which Al-12% Si alloy is used for the welding part 2 with thickness of 2.2 mm, Al-50% Si alloy is used for the transition part 3 with thickness of 4.0 mm, and Al-70% Si alloy is used for the bottom 1 with thickness of 1.8 mm.

In some other embodiments, the number of transition parts 3 is greater than 1, and a plurality of transition parts 3 arranged in a gradient of silicon content can be designed according to requirements. For example, as shown by FIG. 9, an electronic packaging shell 100b includes a first transition part 31 and a second transition part 32. The first transition part 31 and the second transition part 32 are both made of high-silicon aluminum alloy, and the silicon content of the first transition part 31 is greater than that of the second transition part 32. The first transition part 31 is connected with the second transition part 32 with the silicon content varies in order from the large to the small along the direction from the bottom 1 to the welding part 2.

S2: Generating a gradient material ingot 100′ via the dual atomization system deposition device, according to the structure of the gradient material of Al-12% Si/Al-50% Si/Al-70% Si. The gradient material ingot 100′ includes a connection layer 1′, a transition layer 3′ and a welding layer 2′, wherein the silicon content vary gradually from large to small along the direction from the connection layer 1′ to the welding layer 2′. The connection layer 1′ is made of Al-70% Si alloy, the transition layer 3′ is made of Al-50% Si alloy, and the welding layer 2′ is made of Al-12% Si alloy.

S3: Densifying the gradient material ingot 100′ by hot pressing sintering, with the densification temperature of 500° C., the holding time of 4 hour, the heating rate of 10° C./hour and the cooling rate of 20° C./hour. Before reaching the densification temperature, the gradient material ingot 100′ is kept at 400° C. for one hour.

After testing, the surface quality of the Al-12% Si/Al-50% Si/Al-70% Si gradient material is good, the interface between the gradient layers is clear with a straight distribution, which has good processing properties and can be processed to a high-silicon aluminum alloy electronic packaging shell, which meets the application requirements.

S4: Cutting the gradient material ingot 100′ into the electronic packaging shell 100a. The connection layer 1′ serves as the bottom 1 after cutting. The transition layer 3′ and the welding layer 2′ are cut to form a frame shape, the transition layer 3′ serves as the transition part 3, and the welding layer 2′ serves as the welding part 2 after cutting.

The thickness h₁ of the bottom 1 is 2.1±0.1 mm and the thickness h₃ of welding part 2 is 2.5±0.1 mm, that is, after cutting, the thickness of the Al-70% Si alloy is 2.1±0.1 mm and the thickness of the Al-12% Si alloy is 2.5±0.1 mm. Since the thickness h₂ of the Al-50% Si alloy for the transition part 3 has been set in the deposited gradient material ingot 100′ in the step S2, it is only necessary to determine the thickness of the Al-12% Si alloy and the thickness of the Al-70% Si alloy to cut the ingot 100′ into a block with the required size. The electronic packaging shell 100a is obtained after further fine engraving the block.

S5: Annealing the electronic packaging shell 100a, with the annealing temperature of 400-440° C. and the holding time of 12-24 hours. During the annealing process, the pressure of 2.5-5 MPa is applied on the electronic packaging shell 100a.

### Embodiment 3

In this embodiment, a method of manufacturing a high-silicon aluminum alloy electronic packaging shell 100a includes steps of:

S1: Designing a silicon aluminum alloy gradient material ingot 100′ and a size of the electronic packaging shell 100a.

Referring to Table 1 and FIGS. 3-5, based on the service conditions and shell structure, via analyzing the temperature and thermal stress distribution of the known typical high-silicon aluminum alloy electronic packaging shell 100 as a reference, figuring out the composition and thickness of each layer of the electronic packaging shell 100a by using thermoelastic theory and finite element calculation.

As shown by FIG. 6, the electronic packaging shell 100a is a box shape, which includes a bottom 1 and a side wall 10, and the bottom 1 and the side wall 10 are enclosed to form a holding space. The side wall 10 includes a transition part 3 and a welding part 2, and the welding part 2 is located above the transition part 3. The number of the transition part 3 can be ≥0, and when the number of the transition part 3 is 0, the welding part 2 is connected with the bottom 1.

According to the known typical high-silicon aluminum alloy electronic packaging shell 100, as shown by FIG. 2, the size of the electronic packaging shell 100a is preset as 40×25×10 mm. The bottom 1 is preset as Al-70Si alloy which is the same material of the chip, and its thickness h₁ is preset as 2.2 mm. The welding part 2 is preset as Al-27Si alloy which is the same material of the cover. Thereafter the main design parameters are simplified to the composition of the transition part 3 and the thicknesses h₂, h₃ of the transition part 3 and welding part 2. The composition of the transition part 3 and the thicknesses h₂, h₃ of the transition part 3 and the welding part 2 are figured out by using the thermoelastic theory and finite element calculation. With the composition of the transition part 3 and the thicknesses h₂, h₃ of the transition part 3 and the welding part 2 as known parameters, the compositions of the bottom 1 and the welding part 2 and the thickness h₁ of the bottom 1 are calculated by using the thermoelastic theory and finite element calculation. In such a way, the compositions of the bottom 1, the transition part 3 and the welding part 2 and their thicknesses are all worked out.

In this embodiment, according to the temperature and thermal stress distribution, using the method of thermoelastic theory and finite element calculation, a gradient material of Al-27% Si/Al-35% Si/Al-50% Si is used to prepare the electronic packaging shell 100a, of which Al-27% Si alloy is used for the welding part 2 with thickness of 2.2 mm, Al-35% Si alloy is used for the transition part 3 with thickness of 4.2 mm, and Al-50% Si alloy is used for the bottom 1 with thickness of 1.8 mm.

S2: Generating a gradient material ingot 100′ via the dual atomization system deposition device, according to the structure of the gradient material of Al-27% Si/Al-35% Si/Al-50% Si. The gradient material ingot 100′ includes a connection layer 1′, a transition layer 3′ and a welding layer 2′, wherein the silicon content vary gradually from large to small along the direction from the connection layer 1′ to the welding layer 2′. The connection layer 1′ is made of Al-50% Si alloy, the transition layer 3′ is made of Al-35% Si alloy, and the welding layer 2′ is made of Al-27% Si alloy.

S3: Densifying the gradient material ingot 100′ by hot pressing sintering, with the densification temperature of 500° C., the holding time of 4 hour, the heating rate of 10° C./hour and the cooling rate of 20° C./hour. Before reaching the densification temperature, the gradient material ingot 100′ is kept at 400° C. for one hour.

After testing, the surface quality of the Al-27% Si/Al-35% Si/Al-50% Si gradient material is good, the interface between the gradient layers is clear with a straight distribution, which has good processing properties and can be processed to a high-silicon aluminum alloy electronic packaging shell 100a, which meets the application requirements.

S4: Cutting the gradient material ingot 100′ into the electronic packaging shell 100a. The connection layer 1′ serves as the bottom 1 after cutting. The transition layer 3′ and the welding layer 2′ are cut to form a frame shape, the transition layer 3′ serves as the transition part 3, and the welding layer 2′ serves as the welding part 2 after cutting.

The thickness h₁ of the bottom 1 is 2.1±0.1 mm and the thickness h₃ of the welding part 2 is 2.5±0.1 mm, that is, after cutting, the thickness of the Al-50% Si alloy is 2.1±0.1 mm and the thickness of the Al-27% Si alloy is 2.5±0.1 mm. Since the thickness h₂ of the Al-35% Si alloy for the transition part 3 has been set in the deposited gradient material ingot 100′ in the step S2, it is only necessary to determine the thickness of the Al-27% Si alloy and the thickness of the Al-50% Si alloy to cut the ingot 100′ into a block with the required size. The electronic packaging shell 100a is obtained after further fine engraving the block.

S5: Annealing the electronic packaging shell 100a, with the annealing temperature of 400-440° C. and the holding time of 12-24 hours. During the annealing process, the pressure of 2.5-5 MPa is applied on the electronic packaging shell 100a.

What is claimed:

1. A method of manufacturing an electronic packaging shell, comprising the steps of:
S1: designing a silicon aluminum alloy gradient material ingot and a size of the electronic packaging shell; the gradient material ingot comprises a connection layer, transition layer(s) and a welding layer, the transition layer(s) is located between the connection layer and the welding layer, the number of the transition layer(s) is ≥0, and the gradient material ingot has a silicon content gradient that decreases along a direction from the connection layer to the welding layer; the electronic packaging shell comprises a bottom and a side wall, the bottom and the side wall are enclosed to form a holding space, the side wall is composed of transition part(s) and a welding part, the transition part(s) is located between the bottom and the welding part, and the number of the transition part(s) is ≥0;
S2: using silicon aluminum alloys with different silicon contents as raw materials, and depositing the connection layer, the transition layer(s) and the welding layer in sequence by atomized spray deposition process to form the gradient material ingot designed by the step S1;
S3: densifying the gradient material ingot;
S4: cutting the gradient material ingot into the electronic packaging shell; the bottom is formed by cutting the connection layer, and the side wall is formed by cutting the transition layer(s) and the welding layer; and
S5: annealing the electronic packaging shell.

2. The method of claim 1, wherein the step S1 comprises: (1) detecting quantitative relationships between silicon content and material properties and process properties of silicon aluminum alloy; (2) referring to temperature and thermal stress distribution of known typical silicon aluminum alloy electronic packaging shell, and according to the quantitative relationships, designing respective composition and thickness of the bottom, the transition part(s) and the welding part.

3. The method of claim 2, wherein in the step (1), the material properties comprise tensile strength, hardness, thermal conductivity and thermal expansion coefficient, and the process properties comprise machining, surface plating and laser welding.

4. The method of claim 2, wherein the step (2) comprises: setting a preset composition and a preset thickness of the bottom and a preset composition of the welding part, then taking the preset composition and the preset thickness of the bottom and the preset composition of the welding part as known quantities, calculating and designing the composition and thickness of the transition part(s) and the thickness of the welding part by using thermoelastic theory and finite element method, then taking the composition and the thickness of the transition part(s) and the thickness of the welding part as known quantities, calculating and designing the composition and the thickness of the bottom and the composition of the welding part by using thermoelastic theory and finite element calculation.

5. The method of claim 1, wherein in the step S2, the atomized spray deposition process adopts a melting temperature of 1200-1500° C. and nitrogen gas with a pressure of 0.7-1.2 MPa for spraying.

6. The method of claim 1, wherein in the step S3, the gradient material ingot is densified by one of hot isostatic pressing, hot pressing sintering and spark plasma sintering, and a densification temperature of 480-550° C., a holding time of 1-4 hours, a heating rate of 10-40° C./hour and a cooling rate of 20-50° C./hour are adopted.

7. The method of claim 1, wherein: in the step S5, an annealing temperature of 320-440° C. and a holding time of 6-24 hours are adopted, and a pressure of 0.5-5 MPa is applied above the electronic packaging shell during annealing.

8. The method of claim 1, further comprising S6: characterizing the electronic packaging shell, and cycling the steps S1-S5 according to characterization results to optimize the respective composition and thickness of the bottom, the transition part(s) and the welding part.

9. The method of claim 1, wherein a silicon mass content of the connection layer is 50-70%, a silicon mass content of the transition layer(s) is 35-50%, and a silicon mass content of the welding layer is 12-35%.

10. An electronic packaging shell, comprising a bottom and a side wall; the bottom and the side wall are enclosed to form a holding space, the side wall is composed of transition part(s) and a welding part, the transition part(s) is located between the bottom and the welding part, and the number of the transition part(s) is ≥0;
the electronic packaging shell is formed from silicon aluminum alloys with different silicon contents as raw material through atomized spray deposition process, densification, annealing and cutting, and has a silicon content gradient that decreases along a direction from the bottom to the welding part.

11. The electronic packaging shell of claim 10, wherein a silicon mass content of the bottom is 50-70%, a silicon mass content of the transition part(s) is 35-50%, and a silicon mass content of the welding part is 12-35%.
